(19) United States
(12) Patent Application Publication
(10) Pub. No.: US 2009/0074014 A1
(43) Pub. Date: Mar. 19, 2009

(54) MODE SELECTION FOR SINGLE FREQUENCY FIBER LASER

(76) Inventor: Jian Liu, Sunnyvale, CA (US)

Correspondence Address: XIN WEN, 3449 RAMBOW DRIVE, PALO ALTO, CA, 94306, US

(21) Appl. No.: 12/239,454

(22) Filed: Sep. 26, 2008

Related U.S. Application Data
(63) Continuation of application No. 10/937,212, filed on Sep. 9, 2004.
(60) Provisional application No. 60/501,217, filed on Sep. 9, 2003.
(60) Provisional application No. 60/503,885, filed on Sep. 22, 2003.
(60) Provisional application No. 60/560,982, filed on Apr. 12, 2004.

(51) Int. Cl. H01S 3/30

(52) U.S. Cl. 372/6

(57) ABSTRACT

A method for generating a laser projection by employing a laser gain medium for receiving an optical input projection from a laser pump. The method further includes a step of generating a laser of a resonant peak from a single mode selection filter.

This Formal Application claims a Priority Date of Sep. 9, 2003 benefit from a Provisional Patent Application 60/501,217, and Sep. 22, 2003 benefited from Provisional Applications 60/503,885 and Apr. 12, 2004 benefited from Provisional Application 60/560,982 filed by the same Applicant of this Application filed on Sep. 9, 2003, Sep. 22, 2003, and Apr. 12, 2004 respectively.

### FIELD OF THE INVENTION

The present invention relates generally to apparatuses and methods for providing high power laser sources. More particularly, this invention relates to new configurations and methods for providing compact and high power pulse shaping fiber laser suitable for implementation in high data rate free space telecommunication systems.

### BACKGROUND OF THE INVENTION

Even though the single frequency fiber laser has a great potential for broad future applications, however, such applications have not yet been practically realized due to the fact that the conventional technologies for providing single frequency fiber laser are still confronted with several technical difficulties. Specifically, a single frequency fiber laser requires a longer gain medium such as Er and Yb doped fiber. There are many different approaches as will be further discussed below, in attempt to resolve this difficulty, however, a satisfactory solution still has not be disclosed. Meanwhile, there are increasing demands to provide a solution to overcome this difficulty in order to practically implement the single frequency laser in broad varieties of applications in the fields of coherent laser radar (LIDAR), coherent communications, and instrumentation in providing narrow line-width sown to a few kHz with simple cavity structure and power efficient operation.

Various approaches have been proposed to target single mode operation of the fiber lasers. Different ways of writing fiber Bragg gratings (FBG) to a short length of fibers to form a small cavity such that the large mode spacing can be obtained and separated. These different methods of writing the fiber Bragg gratins are disclosed by L. Dong, W. H. Loh, J. E. Capln, and J. D. Minelly, “Efficient single frequency lasers with novel photosensitive Er/Yb optical fibers,” Opt. Lett. 22(10), 694-696 (1997); J. L. Zyskind, V. Mizrahi, D. J. DiGiovanni, and J. W. Sulhoff, “Short single frequency Erbium doped fiber laser,” Electronics Lett. 28(15), 1385-1387 (1992); and G. A. Ball W. W. Morey, and W. H. Glenn, “Standing wave monomode Erbium fiber laser,” IEEE Photon. Technol. Lett. 3 (7), 613-615 (1991). A way of using a phase shifted FBG to select single mode operation is disclosed by G. A. Ball W. W. Morey, and W. H. Glenn in a paper entitled J. J. Pan and Y. Shi, “166 mW single frequency output power interactive fiber laser with low noise,” IEEE Photon. Technol. Lett. 11(1), 36-38 (1999). However, all these approaches tend to write FBG on the gain medium which is not easy to control the fabrication process. Phase shifted FBG even add more complex. On the other hand FBG is more temperature sensitive. M. Auerbach, P. Adel, et al., discloses a method by using bulk gratings for single frequency operation in an article entitled “10 W widely tunable narrow linewidth double clad fiber ring laser,” Optics Express 10 (2), 139-144 (2003). However the bulky structure make it less attractive to practical applications.

Therefore, a need still exists in the art of fiber laser source design and manufacture to provide a new and improved configuration and method to provide single frequency fiber laser such that the above discussed difficulty may be resolved.

### SUMMARY OF THE PRESENT INVENTION

It is therefore an object of the present invention to provide a single frequency fiber laser to provide laser output of sharp and stable highly defined frequency such that the above described difficulties encountered in the prior art can be resolved.

Briefly, in a preferred embodiment, the present invention discloses a single frequency fiber laser that includes a laser gain medium for receiving an optical input projection from a laser pump. The fiber laser further includes a single mode selection filter for generating a resonant peak for projecting to a set of Bragg gratings for partially reflecting a single frequency laser. In a preferred embodiment, the fiber laser further includes a temperature controller to control a temperature of the fiber laser substantially within one degree Celsius. In another preferred embodiment, the fiber laser further includes a polarizer for projection a substantially single polarization laser. In another preferred embodiment, the fiber laser further includes a fiber mirror for reflecting back a lasing light with a transmitted light from the Bragg gratings as an output single frequency fiber laser. In another preferred embodiment, the fiber laser further includes an isolator for preventing a reflection light returning to the fiber laser. In another preferred embodiment, the fiber laser further includes a bandwidth of the set of Bragg gratings is smaller than a bandwidth of the mode selection filter. In another preferred embodiment, the mode selection filter further includes a pair of notch filters constituting a Fabry-Perot cavity.

In essence this invention discloses fiber laser that includes a laser gain medium for receiving an optical input projection from a laser pump, wherein the fiber laser further includes a single mode selection filter for generating a laser of a resonant peak.

In a preferred embodiment, this invention further discloses a method for generating a laser projection by employing a laser gain medium for receiving an optical input projection from a laser pump. The method further includes a step of generating a laser of a resonant peak from a single mode selection filter.

In a preferred embodiment, this invention further discloses a mode selection filter that includes a pair of notch filters constituting a Fabry-Perot cavity. In a preferred embodiment, the pair of notch filters are a pair of reflective notch filters. In a preferred embodiment, the pair of notch-filters constituting a Fabry-Perot cavity having a cavity distance substantially equal or less than two millimeters. In a preferred embodiment, the pair of notch filters are a pair of notch filters attached to two end surfaces of two GRIN lens. In a preferred embodiment, the pair of notch filters are a pair of high reflection filters attached to two end surfaces of two GRIN lens constituting a Fabry-Perot cavity with a narrow band pass filter disposed in the cavity.

These and other objects and advantages of the present invention will no doubt become obvious to those of ordinary skill in the art after having read the following detailed description of the preferred embodiment, which is illustrated in the various drawing figures.

### BRIEF DESCRIPTION OF THE DRAWINGS

FIGS. 1A to 1C, are side cross sectional views for showing a mode selection filter implemented as a key component in the single frequency fiber laser of this invention.

FIGS. 2A and 2B illustrate two transmission curves for a notch filter and a bandpass filter respectively.

FIG. 3 shows a transmission curve for the mode selection filter of FIGS. 1A to 1C.

FIG. 4A shows the transmission curves of the Fabry Parrot (FP) filters as shown in FIGS. 1A to 1C

FIG. 4B showing the narrow bandwidth spectrum achieved by using long cavity and high reflectance surfaces in the filters of FIGS. 1B and 1C.

FIGS. 5A to 5D are functional block diagrams for showing four alternate embodiments of single frequency laser sources.

FIG. 6 is a functional block diagram for showing a ring shaped single frequency laser sources.

FIG. 7 is a diagram for illustrating the mode spacing and frequency drift as a function of the cavity length of ring laser.

FIG. 8A shows a fiber or optical waveguide ring resonator mode selector.

FIG. 8B shows a super structured fiber Bragg grating (FBG) mode selector.

FIG. 8C shows a spectrum of a super structured FBG for narrow line-width fiber laser.

FIG. 9 shows an alternate embodiment to achieve single narrow line-width fiber laser using semiconductor gain medium.

FIG. 10 shows FBGs and a phase shift in a PM gain medium.

### DETAILED DESCRIPTION OF THE INVENTION

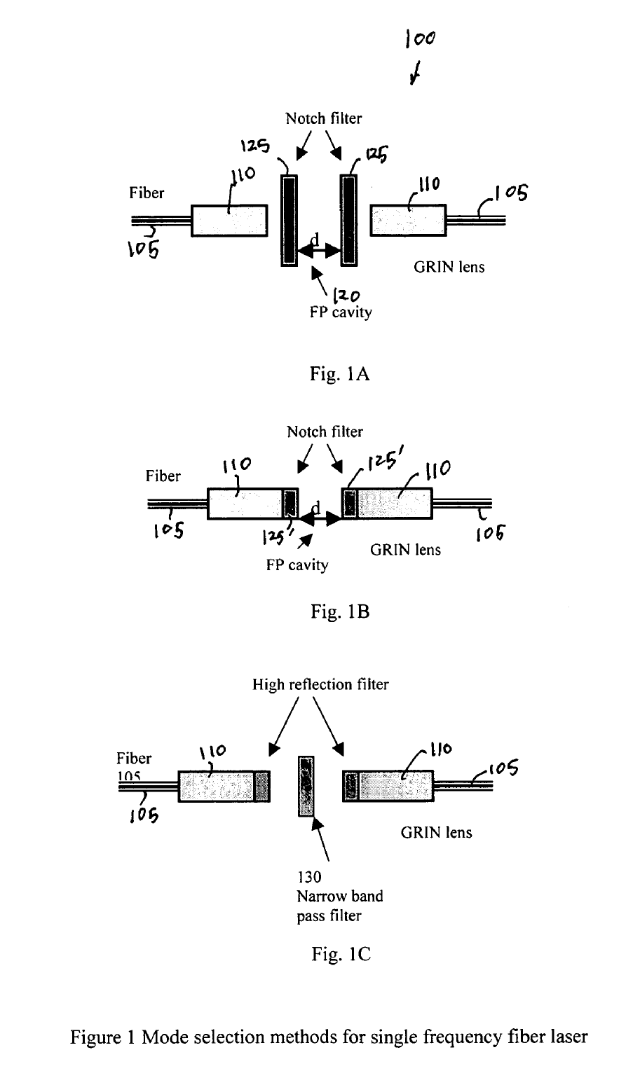

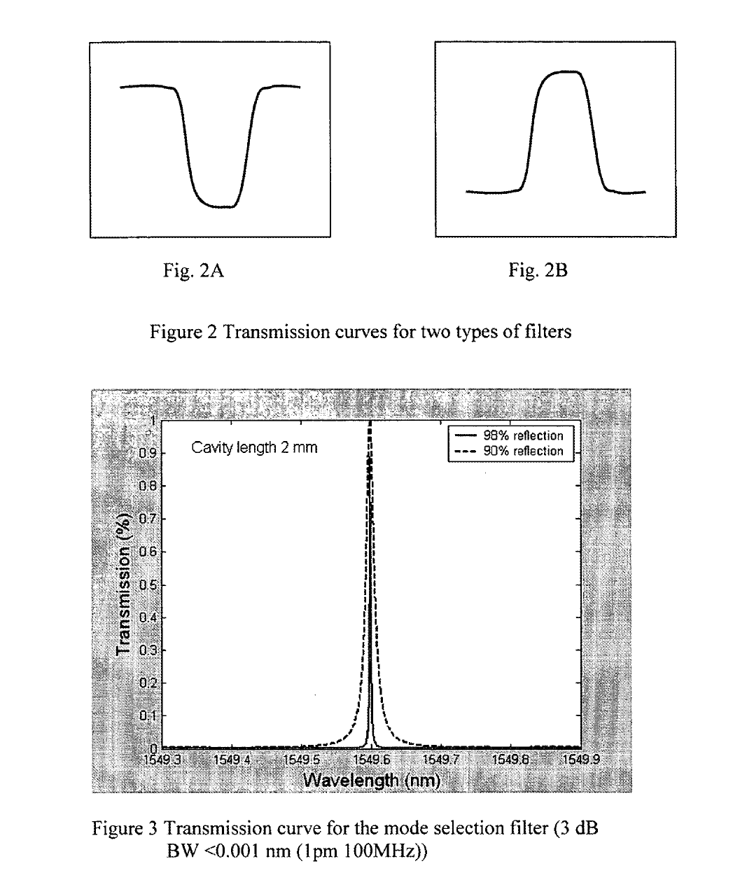

This invention discloses a new approach to generate a single frequency fiber laser by employing a mode selection filter implemented with commercially available components. The key part of the approach is the mode selection device as that shown in FIGS. 1A to 1C wherein a mode selection filter 100 is implemented with a notch filter. A notch filter is a band rejection filter with a narrow bandwidth, e.g., 100 GHz or 200 GHz. The notch filter is widely used in telecommunications. The band rejection waveform of the notch filter has a shape as that shown in FIG. 2A that has a reverse waveform of a bandpass filter as that shown in FIG. 2B. Referring to FIG. 1A again where two optical fibers 105 are connected to two GRIN lenses 110 wherein each GRIN lens 110 functions as a collimate lens to generate collimated beams go through a Fabry-Perot cavity 120 formed by two notch filters 125-1 and 125-2. The resonance occurs only for the narrow band region. By controlling the distance “d” between the two filters 125-1 and 125-2, one resonance peak can be obtained within the band of interest. FIG. 3 shows a simulation result for a pair of notch filter that has a 100 G Hz bandwidth arranged according to a configuration of FIG. 1A forming a cavity 120 with a distance d=2 mm between the notch filters. Only one peak is obtained within the band. In FIG. 3, a reflection of 98% shows a 3 dB bandwidth <100 MHz, which corresponding to about longitudinal mode separation of 1 m length of fiber cavity and good enough to make single mode operation, i.e., mode separation in laser cavity=c/2 nL, where c is the speed of light, n is the refractive index of fiber, L is fiber cavity length. Referring to “A. Yariv, optical Electronics in Modern Communications, 5^{th} edition, Oxford, 1997”. Such mode separation leads to the laser line width at the order of kHz. By using a high reflection filter (>99%), the bandwidth can be reduced to a few kHz.

In addition to the configuration as that shown in FIG. 1A, alternative approaches can be made by coating notch filters 125′ directly on the two collimator surfaces as shown in FIG. 1B, or by inserting a band pass filter 130 between two high reflection surfaces as that shown in FIG. 1C. The finesse of the filter is controlled by the reflectance of the two cavity surfaces. The bandwidth and the free spectral range is controlled by the cavity distance and the reflectance according to the following corresponding equations:

$$\begin{matrix}Finesse F = π \frac{\sqrt{R}}{1 - R} & ( 1 ) \\ \begin{matrix}Free spectral range F S R & F S R = \frac{c}{2 nl}\end{matrix} & ( 2 ) \\ \begin{matrix}Bandwidth & B W = \frac{c}{2 π nl} \frac{1 - R}{\sqrt{R}}\end{matrix} & ( 3 )\end{matrix}$$

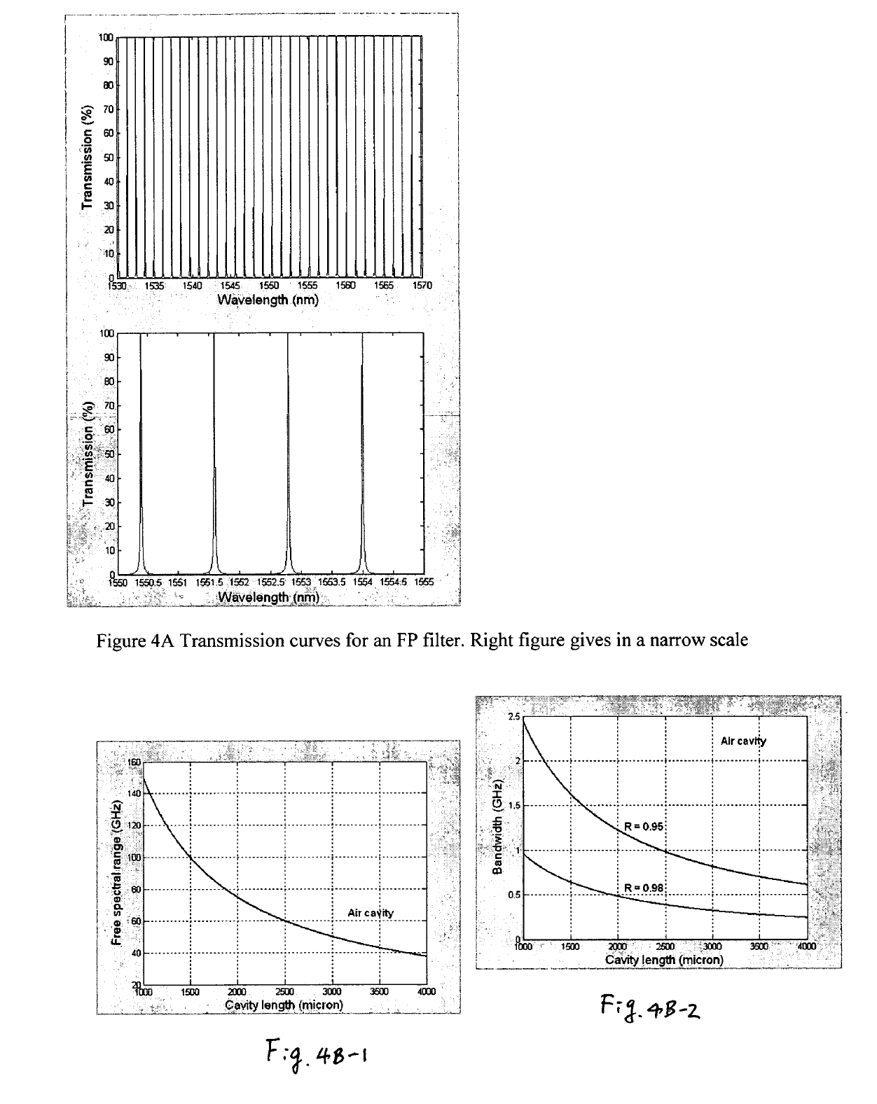

A simulation result is given in FIGS. 4A and 4B. A cavity length of 2 mm and reflectance of 0.95 are used in the simulation. The FP cavity provides a good confinement of light in the cavity and spectra with extremely narrow free spectral range.

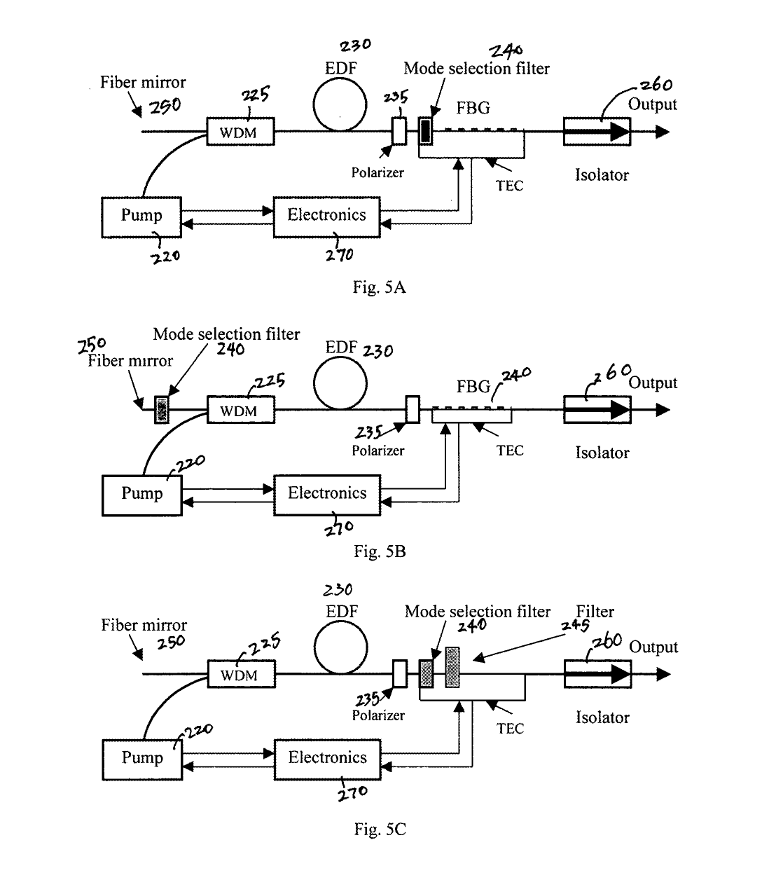

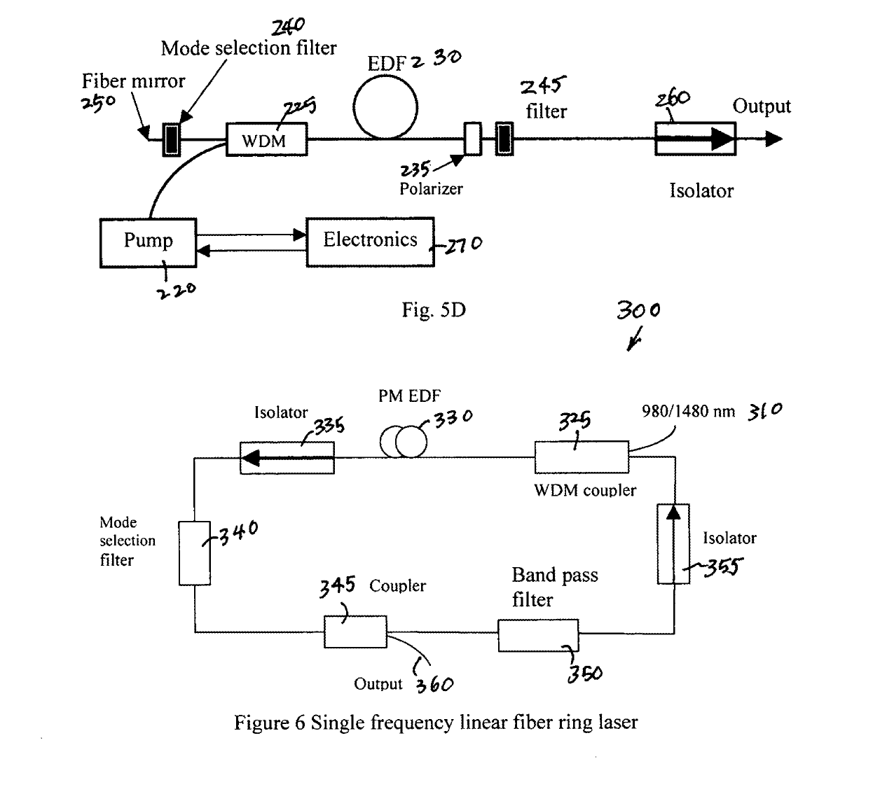

FIGS. 5 A and 5B show two alternate configurations for providing a single frequency fiber laser. In FIG. 5A, a laser pump 220, e.g., either a 980 nm or a 1480 nm pump, generates a laser input to project via a wavelength division multiplexing (WDM) 225 to pump an Erbium doped fiber (EDF) 230 for operating at a 1550 nm region. A polarizer 235 is implemented to assure no polarization competition in the laser cavity. The polarizer 235 is optional. The laser is then projected from the polarizer 235 to a mode selection filter 240. The mode selection filter 240 is applied to select one mode within the bandwidth of interest and a fiber Bragg gratings (FBG) 245 then partially reflect the selected mode and partially transmitting the lasing mode. The bandwidth of the FBG is smaller than that of the notch filter in the mode selection filter 240. The single fiber laser also includes a fiber mirror 250 to reflect back the lasing light to project together with the transmitted light from the FBG 245 as an output single frequency fiber laser through an isolator 260 to prevent any reflection light returning the cavity. With the model selection filter 240 working together the FBG 245, a single frequency fiber laser is provided with greater flexibility for length adjustment for the optical fiber laser than that is available for the single frequency laser implemented by the conventional techniques. The approach here uses commercially available components and can be fabricated by applying simplified assembling processes. The electronics 270 is provided to control for pump laser diode and for controlling the temperature of the mode selection unit in stabilization of the frequency.

FIG. 5B shows an alternate configuration of FIG. 5A by placing the mode selection filter 240 at the other end of the fiber cavity opposite the FBG 245. For the purpose of generating single frequency laser, a temperature control is required to control the FBG 245, the mode selection filter 240 and/or the laser cavity within one degree of Celsius to minimize the KHz line-width. A temperature dependent frequency shift is in the order of KHz per degree of temperature change, this is due to the refractive index change of the fiber with the temperature at the order of 10⁻⁵/degree as further explained below. Mode spacing and frequency shift over temperature are two parameters correlated to the cavity length of the fiber laser. In the ring structure cavity laser as shown in FIG. 6, the mode spacing is defined by

$$Δ v = \frac{c}{nl} ; \qquad ( 4 )$$

where c is the speed of the light, n the index of refraction, l the laser cavity length, and v is the frequency. The temperature change causes a change of the index of refraction at a rate of 10⁻⁵/degree. This induces the equivalent cavity length change and the frequency drift of the lasing. The temperature dependent frequency drift is given by

$$\frac{d ( Δ v )}{d T} = \frac{c}{nl} \cdot \frac{d n}{d T} = Δ v \cdot \frac{d n}{d T} \qquad ( 5 )$$

In order to generate high power single frequency laser, a high doping concentration of the EBG, e.g., 5×10²⁵ m⁻³, can be implemented with shorter length. Higher doping concentration fiber helps reduce the length of the laser cavity while maintaining an acceptable output power. For instance, if the doping is increased two times, basically it is expected that a reduction of the length of gain fiber by two times to obtain the same level of output power. In an alternate embodiment, the FBG 140 in FIGS. 5A and 5B can be replaced by a thin film filter as that shown in FIGS. 5C and 5D to achieve an identical operating functionality. The filter should be designed to have a certain reflection between the reflections of 10% to 90% to provide the feed back to the lasing cavity at the lasing wavelength/frequency.

FIG. 6 shows an alternate preferred embodiment where a single frequency fiber ring laser 300 is shown. The single frequency fiber ring laser 300 is a unidirectional cavity, which reduces the spatial hole burning to stabilize the frequency in obtaining high power operation. The ring laser 300 includes a 980/1480 nm laser pump 310 to transmit a laser through a WDM 325 to a gain medium PM EDF 330. The laser then projects through a first isolator 335 to a mode selection filter 340 to select a single mode operation. The coupler 345 is for outputting a laser output 360 at a pre-selected ratio. One or two isolators, e.g., a second isolator 355 are used to assure the uni-direction operation. The single frequency generation is similar to that of linear cavity with except that the laser project is along a single direction and there is no reflection as that implemented in some of the above described embodiments.

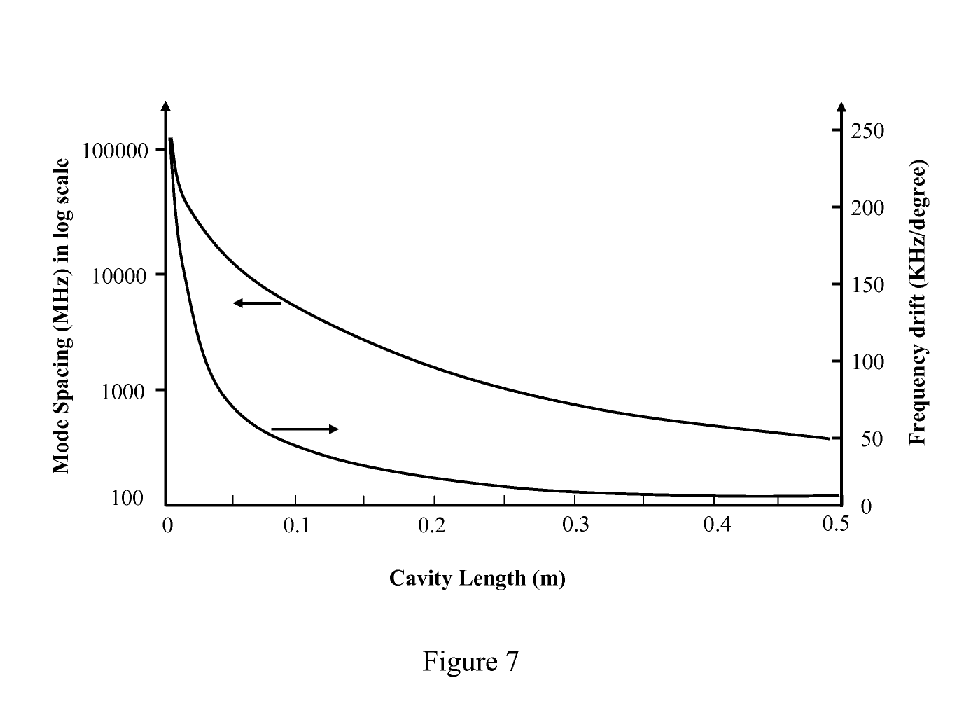

FIG. 7 shows a simulation on the mode spacing and frequency drift as a function of ring cavity length. The mode spacing is inversely proportional to the cavity length. Large cavity length causes small lasing mode spacing and difficult to discriminate by filtering. However, It has the advantage of less sensitive to the temperature. When short cavity length used in the laser, accurate temperature control is needed to reduce the frequency drift. For example, 1 mm linear laser cavity will give 2 GHz/degree frequency drift. To make the frequency drift within a few kHz or MHz, the temperature has to be controlled within one-thousandth degree! While longer length of cavity gives only few kHz frequency drift per degree temperature change. This makes the long cavity more robust and more practical in implementation. To overcome the mode selection issue, a length of 0.5-meter cavity may be a good choice with its 400 MHz mode spacing and 4-kHz/degree temperature-dependent frequency drifts.

The exemplary embodiment is for single frequency fiber laser that operates at the 1550 nm region, for a single frequency fiber laser to operate at 1060 laser, a Yb doped fiber can be used instead the laser pump generates a laser input at 980 nm or 915 nm. The optical fiber employed in the above embodiments may either be a non-polarization maintaining fiber or a polarization maintaining (PM) fiber. A PM fiber provides better frequency stability even though a PM is more costly to implement. Since a polarization mode competition always presents in the fiber laser because a regular fiber always supports two eigen-polarization excitations. For this reasons, a PM fiber may be more desirable as it provides frequency stability by preventing a condition of “competition between two polarization modes” as that may occur in a non-polarization maintaining fiber.

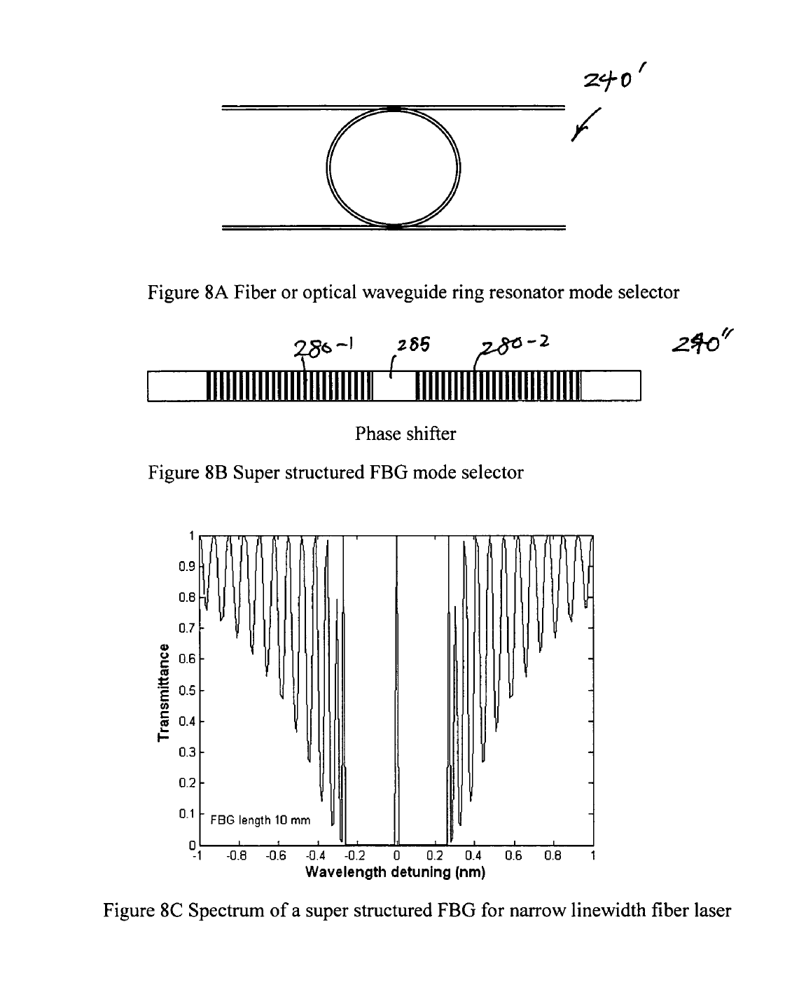

An alternate embodiment of this invention is shown in FIGS. 8A and 8B. FIG. 8A shows a fiber or optical waveguide ring resonator mode selector 240′. The resonator mode selector 240′ may be implemented as a mode selection filter in FIGS. 5A and 5B. FIG. 8B shows a super structured fiber Bragg gratings (FBG) mode selector 240″, and FIG. 8C shows a spectrum of a super structured FBG for narrow line-width fiber laser. In FIG. 8B, the super structured FBG mode selector 240″ a structure including two high reflectance FBGs 280-1 and 280-2 with a spacing between them to form a fiber based FP cavity. The spacing 285 is design to have a phase shift of ¼λ to generate a very narrow peak of transmission in the band of reflection of the FBGs.

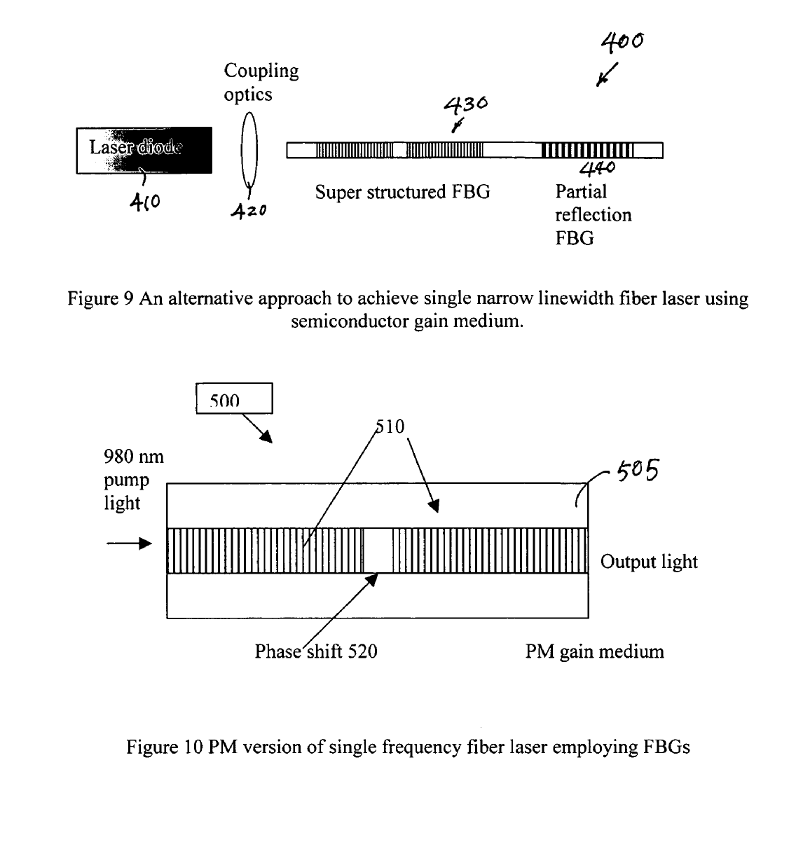

FIG. 9 shows another embodiment of this invention where a single frequency laser 400 is implemented by projecting a laser input generated from a laser diode 410 through a coupling optics 420 to a super structured FBG 430 and a partial reflection FBG 440. The semiconductor in provided in FIG. 9 as gain material and the super structure FBG 430 and the partial reflection FBG 440 are implemented mode selection filter. It works in a similar way of FIG. 5 except gain medium here is semiconductor.

FIG. 10 is a cross sectional view of a polymer based polarization maintenance (PM) single frequency laser 500 provided in this invention to achieve single mode fiber laser by using PM gain mediums, such as PM Yb doped single mode fiber, PM Er doped single mode fiber, PM Yb doped double cladding fiber, PM Er doped double cladding fiber, PM Yb/Er co-doped double cladding fiber, and other waveguide type gain medium. The operating lasing wavelengths can be in the regions of 1550 nm and 1060 nm.

The polarization maintenance (PM) single frequency laser 500 includes fiber Brag gratings (FBG) 510 written in the photosensitive PM fibers 505 by using a mask or holographic interference method in a length of several centimeters. A phase shift 520 is cooperated in the writing to suppress the side modes and assure single frequency operation. By controlling the temperature, the laser is operated at either of the eigen polarizations of the PM fibers. A 980 nm pump can be used to pump the gain medium form one end of the laser. 915 and 940 nm can be employed if the fiber has Yb doped. This is an approach by employing a PM gain medium and writing FBG in the PM gain medium thus providing a mode selection filter for implementation in the single frequency laser described above.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

1-66. (canceled)

67. A single-frequency fiber laser, comprising:
a laser gain medium configured to produce a first laser beam comprising a plurality of resonant modes;
a fiber Bragg grating (FBG) mode-selection filter comprising:
a first fiber Bragg grating configured to receive the first laser beam, wherein the first fiber grating comprises a first reflective surface; and
a second fiber Bragg grating having a second reflective surface substantially parallel to the first reflective surface, wherein the first reflective surface and the second reflective surface form a Fabry-Perot cavity there between, wherein the Fabry-Perot cavity is configured to select a resonant mode among the plurality of resonant modes to output a second laser beam having a single resonant mode.

68. The single-frequency fiber laser of claim 67, wherein the first reflective surface and the second reflective surface are separated by a phase-shift space.

69. The single-frequency fiber laser of claim 68, wherein the phase-shift space is at least partially filled by a polymer based medium.

70. The single-frequency fiber laser of claim 68, wherein the phase-shift space is at least partially filled by a polarization maintenance polymer based medium.

71. The single-frequency fiber laser of claim 68, wherein the phase-shift space between the first reflective surface and the second reflective surface is configured to produce a quarter wavelength phase shift in the first laser beam or the second laser beam.

72. The single-frequency fiber laser of claim 67, wherein the second reflective surface is disposed at a distance in a range between 0.5 mm and 3 mm from the first reflective surface.

73. The single-frequency fiber laser of claim 67, wherein the Fabry-Perot cavity formed between the first fiber Bragg grating and the second fiber Bragg grating has a transmittance bandwidth narrower than 0.2 nm.

74. The single-frequency fiber laser of claim 67, wherein the first reflective surface and the second reflective surface have reflectance higher than 99%.

75. The single-frequency fiber laser of claim 67, wherein the single resonant mode in the second laser beam has a line width smaller than 100 MHz.

76. The single-frequency fiber laser of claim 67, further comprising an isolator configured to receive the second laser beam from the second fiber Bragg grating and transmit at least a portion of the second laser beam toward the first fiber Bragg grating, wherein the laser gain medium, the FBG mode-selection filter, and the isolator in part form a ring-shaped laser cavity.

77. A single-frequency fiber laser, comprising:
a laser pump configured to produce a pump light;
a laser gain medium configured to produce a first laser beam comprising a plurality of resonant modes in response to the pump light;
a super-structured fiber Bragg grating (FBG) mode-selection filter comprising:
a first fiber Bragg grating configured to receive the first laser beam, wherein the first fiber grating comprises a first reflective surface; and
a second fiber Bragg grating having a second reflective surface substantially parallel to the first reflective surface, wherein the first reflective surface and the second reflective surface form a Fabry-Perot cavity there between, wherein the Fabry-Perot cavity is configured to select a resonant mode among the plurality of resonant modes to output a second laser beam having a single resonant mode;
a temperature controller configured to control the temperature of the super-structured FBG mode-selection filter; and
an electronic control unit configured to control the laser pump and the temperature controller to stabilize the frequency of the single resonant mode in the second laser beam.

78. The single-frequency fiber laser of claim 77, wherein the pump source is a laser diode.

79. The single-frequency fiber laser of claim 77, wherein the pump light is at a pump wavelength shorter than the wavelength of the single resonant mode in the second laser beam.

80. The single-frequency fiber laser of claim 77, wherein the temperature controller is configured to control the temperature of the super-structured FBG mode-selection filter within 1 degree Celsius to stabilize the frequency of the single resonant mode in the second laser beam.

81. The single-frequency fiber laser of claim 77, wherein the first reflective surface and the second reflective surface are separated by a phase-shift space.

82. The single-frequency fiber laser of claim 81, wherein the phase-shift space is at least partially filled by a polymer based medium.

83. The single-frequency fiber laser of claim 81, wherein the phase-shift space is at least partially filled by a polarization maintenance polymer based medium.

84. The single-frequency fiber laser of claim 81, wherein the phase-shift space between the first reflective surface and the second reflective surface is configured to produce a quarter wavelength phase shift in the first laser beam or the second laser beam.

85. The single-frequency fiber laser of claim 77, wherein the first fiber Bragg grating has a length between about 1 mm and about 100 mm.

86. The single-frequency fiber laser of claim 77, wherein the Fabry-Perot cavity formed between the first fiber Bragg grating and the second fiber Bragg grating has a transmittance bandwidth narrower than 0.2 nm.

87. The single-frequency fiber laser of claim 77, wherein the second reflective surface is disposed at a distance in a range between 0.5 mm and 3 mm from the first reflective surface.

88. The single-frequency fiber laser of claim 77, wherein the first reflective surface and the second reflective surface have reflectance higher than 99%.

89. The single-frequency fiber laser of claim 77, wherein the single resonant mode in the second laser beam has a line width smaller than 100 MHz.

90. The single-frequency fiber laser of claim 77, further comprising an isolator configured to receive the second laser beam from the second fiber Bragg grating and transmit at least a portion of the second laser beam toward the first fiber Bragg grating, wherein the laser gain medium, the super-structured FBG mode-selection filter, and the isolator in part form a ring-shaped laser cavity.

91. A single-frequency fiber laser, comprising:
a laser pump configured to produce a pump light;
a laser gain medium configured to produce a first laser beam comprising a plurality of resonant modes in response to the pump light;
a super-structured fiber Bragg grating (FBG) mode-selection filter comprising:
a first fiber Bragg grating configured to receive the first laser beam, wherein the first fiber grating comprises a first reflective surface; and
a second fiber Bragg grating having a second reflective surface substantially parallel to the first reflective surface, wherein the first reflective surface and the second reflective surface are separated by a phase-shift space and form a Fabry-Perot cavity there between, wherein the Fabry-Perot cavity has a transmittance bandwidth narrower than 0.2 nm and is configured to select a resonant mode among the plurality of resonant modes to output a second laser beam having a single resonant mode, wherein the phase-shift space between the first reflective surface and the second reflective surface is configured to produce a quarter wavelength phase shift in the first laser beam or the second laser beam;
a temperature controller configured to control the temperature of the super-structured FBG mode-selection filter; and
an electronic control unit configured to control the laser pump and the temperature controller to stabilize the frequency of the single resonant mode in the second laser beam.
